(19) United States
(12) Patent Application Publication
(10) Pub. No.: US 2004/0150141 A1
(43) Pub. Date: Aug. 5, 2004

(54) Non-rubbing liquid crystal alignment method

(76) Inventors: Chih-Yu Chao, Taipei (TW); Wen-Jiunn Hsieh, Chung Ho City (TW); Ta-Kang Chen, Taipei City (TW); Wen-Tse Tseng, Pate City (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/758,423

(22) Filed: Jan. 16, 2004

(30) Foreign Application Priority Data
Jan. 17, 2003 (TW) 92101048

(51) Int. Cl. B29C 35/08; B05D 5/12; B29C 59/02; B29C 71/04; B29C 71/02; B05D 3/12

(52) U.S. Cl. 264/494; 427/256; 427/355; 427/58; 264/293; 264/236

(57) ABSTRACT

A method for forming a non-rubbing alignment film is provided. A polymer film is formed on a substrate. A plurality of microgroove structure is then formed on the surface of the polymer film by the molecular imprint method to prevent electrostatic damage and micro particle contamination produced by the conventional rubbing method.

### BACKGROUND OF THE INVENTION

1. Field of Invention

The present invention relates to a method for fabricating a liquid crystal display. More particularly, the present invention relates to a method for fabricating a non-rubbing alignment film of a liquid crystal display.

2. Description of Related Art

It has been a long time since the discovery of liquid crystals. In the early stage, the application of liquid crystal displays (LCDs) is limited to the screens in small calculators and watches. As the semiconductor industries develop rapidly, the technologies of liquid crystal displays have much progress and becomes mature in these days. Therefore, liquid crystal displays are widely applied in the high quality displays. Compared with the cathode ray tube displays, the LCDs are smaller, light-weighted, user-friendly and radiation-free. Consequently, the market of LCDs keep growing.

So far, most of liquid crystal displays are thin film transistor (TFT) liquid crystal displays. The fabrication process of TFT LCDs can be divided into four sections, comprising: TFT array substrate fabrication, color filter substrate fabrication, liquid crystal (LC) cell assembly and liquid crystal module (LCM) fabrication. After performing the TFT array substrate fabrication and color filter substrate fabrication, the LC cell assembly is performed to assemble the TFT array substrate and the color filter substrate and then inject liquid crystals into the space between the TFT array substrate and the color filter substrate. Afterwards, the LCM fabrication is performed. Generally speaking, the liquid crystal display mainly comprises LC cells, and the LC cell consists of two transparent substrates and liquid crystals sealed between the two substrates.

Before the assembly of the color filter substrate and TFT arrays substrate, each of two opposite inner surfaces of these two transparent substrates should be coated with an alignment film. The aligning direction of the liquid crystal molecule is determined by the rubbing direction of the alignment film.

Conventional manufacturing process of the alignment film includes film printing, baking and rubbing. In the process of film printing, the polyimide solution is dropped by the dispenser onto the anilox roll that rolls clockwise (or counter-clockwise), and the doctor blade rolling counter-clockwise (or clockwise) distributes a polyimide layer on the anilox roll. The polyimide layer is then transferred to the printing roll with the desired pattern, and from there the coating material is transferred to the plate. Next, the baking process is performed to polymerize and imidize the alignment layer through dehydration and cyclolization, as well as to remove the solvent in the alignment layer. The baking temperature is in general lower than 180° C. and the baking process is performed through a thermal process by furnace, hot-plates or IR. Finally, the rubbing process is performed.

FIG. 1 is a display view of the prior art system for fabricating the alignment layer. Referring to FIG. 1, the plate 100 is place on a moving platform 102. The rubbing cloth 104 disposed on the roll 106 rolls along with the roll 106 and rubs the polyimide layer (not shown) on the substrate 100, which increase the alignment ability of the alignment film. The materials for the rubbing cloth can be synthetic fabrics, cotton or nylon. In the rubbing process, since the rubbing cloth is attached onto the roll surface, the rolling roll makes the rubbing cloth rub the alignment film on the substrate surface. Therefore, on the surface of the alignment layer form the straight grooves in a fixed direction. Because the polyimide molecules align with the rubbing directions, the liquid crystal molecules align along the polyimide molecules in the fixed direction.

In the rubbing process, the defects of the fabric or dust attachment on the fabric will deteriorate the rubbing uniformity. If the rubbing is not uniform, it results in serpentine defect zones during rolling in the parallel direction and gives differences in pre-tilt angles degrees, leading to electro-optical fault areas. Moreover, the static charges produced during the rubbing process may decline the quality of TFT devices. The existence of contaminants on the rubbing cloth or dusts will decrease the yield of the LC cells. Since the rubbing process of the alignment film by using the rubbing cloth is commonly applied, it is important to manage the surface characteristics of the rubbing cloth and reduce the static charges. Therefore, it is necessary to develop a method for forming the alignment film without dust contamination and static problems.

### SUMMARY OF THE INVENTION

The present invention provides a method for fabricating an alignment film, suitable to be applied in LCDs, for avoiding electro-optical fault areas from the non-uniform rubbing.

The present invention provides a method for manufacturing an alignment film, suitable to be applied in LCDs, for preventing deterioration of TFT devices by the electrostatic charges produced from fictions.

The present invention provides a method for fabricating an alignment film, suitable to be applied in LCDs, for avoiding the micro-particle contamination by frictions.

As embodied and broadly described herein, the present invention provides a method for forming an alignment film for liquid crystal displays. After a polymer film is formed on the substrate, the polymer film is treated using the molecular imprint method to form a plurality of microgrooves on the surface of the polymer film. The polymer film is made from a polyimide compound or a polyamide compound. The molecular imprint method includes pressing a surface of molecular imprint template onto the polyer film, the surface of the molecular imprint template has embossments to the polymer film to generate the microgrooves. The polymer film can be cured by a thermal process or UV radiation, before or after pressing the molecular imprint template to the polymer film. The temperature of the thermal process for curing the polymer film is preferably lower than 200° C. The molecular imprint template is then separated from the polymer film by using a solvent, an acid solution or a mechanical force. After the removal of the molecular imprint template, the polymer film for aligning the liquid crystal molecules is obtained, and the microgrooves in the polymer film can align the LC molecules along the direction of the microgrooves.

The molecular imprint template is obtained by forming a silicon oxide film through tilt evaporation on the surface of the substrate. The material of the substrate can be plastic or metal or other anti-corrosive materials. Alternatively, the substrate can be processed through micromanipulation to generate micro-slots, and the substrate with micro-slots is the molecular imprint template.

In this invention, the microgrooves are formed complementarily to the embossments of the molecular imprint template, the direction or the profile of microgroove in the alignment film can be precisely tailor-made according to the requirements, by controlling the direction or profile of the embossment in the molecular imprint template. By controlling the ratio of depth A and pitch B, it is possible to control the alignment of the LC molecules to be either homogeneous alignment or hemeotropic alignment. According to the manufacturing method for forming the alignment film described in this invention, the microgrooves can be formed in at least two different directions in one pixel, thus providing wide viewing angles for the liquid crystal displays.

In conclusion, the method for forming the alignment film of this invention can avoid the prior art problems, including electrostatic damages and micro particle contamination. Furthermore, the method of this invention can accurately control the depth, the width and the direction of the microgroove, so as to control the alignment of the LC molecules and provide wide viewing angles for the LCDs.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a display view of the prior art system for fabricating the alignment layer;

FIG. 2 is a display view of the molecular imprint template according to one preferred embodiment of this invention;

FIGS. 3A-3C are cross-sectional views of the process steps for the manufacturing method of the alignment film according to one preferred embodiment of this invention; and

FIG. 4 is a display top view of the molecular imprint template for forming the alignment film with the wide viewing angle, according to another preferred embodiment of this invention.

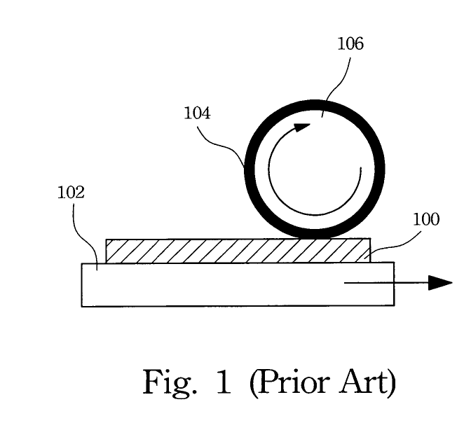

### DESCRIPTION OF THE PREFERRED EMBODIMENTS

The present invention provides a method for forming an alignment film. The alignment film is formed using the molecular imprint method, by pressing a surface of the molecular imprint template onto the polymer film, the surface of the molecular imprint template has embossments to the polymer film to form a plurality of microgroove structures on the surface of the polymer film. According to the method of this invention, the depth, the pitch and the direction of the microgrooves are well controlled, so that the alignment direction of the LC molecules is accurately controlled and the viewing angle of the liquid crystal monitors is increased. Hence, electrostatic damages and micro particle contamination suffered in the conventional rubbing method are prevented.

In the following paragraph, the method for fabricating the alignment layer according to this invention is described in details.

Embodiment 1

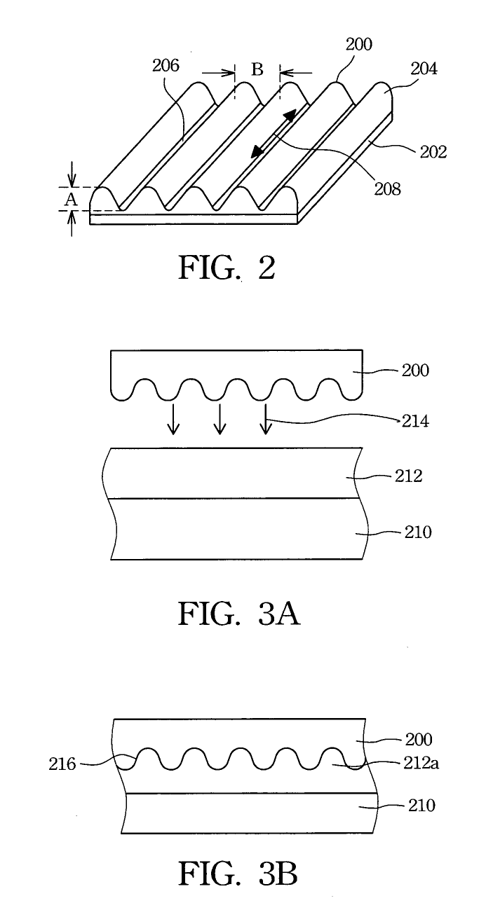

Referring to FIG. 2, illustrating a display view of the molecular imprint template according to one preferred embodiment of this invention. A molecular imprint template 200 is formed on a substrate 202 by forming a silicon oxide film 204 through tilt evaporation on the surface of the substrate 200. The silicon oxide film 204 includes embossment with the desired microgroove pattern for the LD alignment. That is, the protruding portions of the embossment are complementary to the subsequently formed microgrooves. On the other hand, the non-protruding portions of the embossment are in fact micro-slots 206 (i.e. microgrooves). The micro-slot 206 has a depth A, a pitch B (or the distance between centers of two adjacent protruding portions) and an extending direction (as shown in double arrow). The material of the substrate 202 can be plastic or metal or other anti-corrosive materials. Alternatively, the substrate 200 can be processed through micro-manipulation to generate micro-slots. By controlling the ratio of depth A and pitch B, it is possible to control the alignment of the LC molecules to be either homogeneous alignment or hemeotropic alignment. For example, the LC molecules aligned vertically in multi-domain vertical alignment (MVA) mode, while the LC molecules aligned parallel in in-phase switching (IPS) mode. Both modes provide wide viewing angles for the liquid crystal displays.

The LC cell assembly fabrication process is performed after performing the TFT array fabrication process and color filter substrate fabrication process, to assemble the TFT array and the color filter substrate. However, before the LC cell assembly fabrication process, an alignment film that controls the alignment of the LC molecules is formed on the surfaces of the TFT array substrate and the color filter substrate respectively.

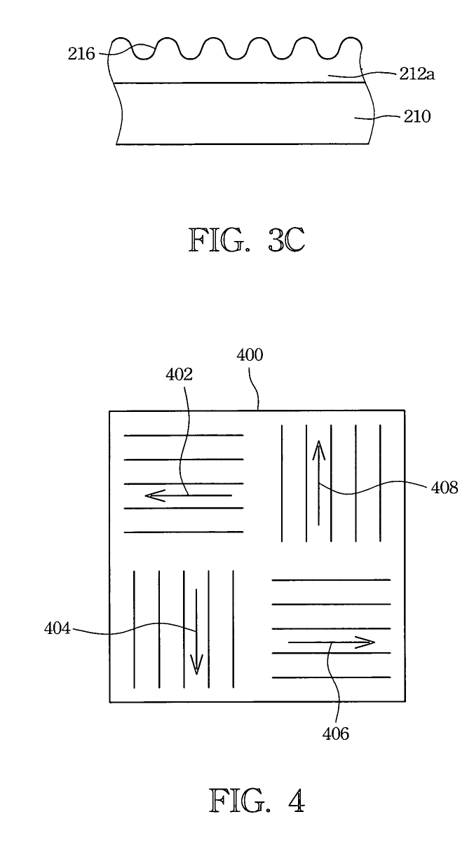

FIGS. 3A-3C are cross-sectional views of the process steps for the fabricating method of the alignment film according to one preferred embodiment of this invention. Referring to FIG. 3A, a polymer film 212 is formed on the substrate 210. The substrate 210 can be either the TFT array substrate or the color filter substrate. In general, the material for forming the polymer film 212 is a polyimide polymer or a polyamide polymer. Using the molecular imprint method, a plurality of microgrooves is formed on the surface of the polymer film 212. The molecular imprint method includes pressing a molecular imprint template 200 downward (in a direction 214 shown in arrow) into the polymer film 212. Referring to FIG. 3B, the molecular imprint template 200 is pressed into the polymer film 212 to form the imprinted polymer film 212a. Because the embossments of the molecular imprint template 200, microgrooves 216 complementary to the protruding portions of the embossments are formed in the imprinted polymer film 212a. Next, the polymer film 212a is cured by either a thermal process or UV radiation.

Referring to FIG. 3C, the molecular imprint template 200 is removed, while the separation of the molecular imprint template 200 from the polymer film 212a is achieved by a solvent (not shown), an acid solution (not shown) or a mechanical force. Therefore, the polymer film 212a for aligning the liquid crystal molecules is obtained, and the microgrooves 216 in the polymer film 212a can align the LC molecules along the direction of the microgrooves.

Embodiment 2

The method disclosed in this embodiment is similar to the method described above, except for different performing orders of the process steps. In the above embodiment, the curing step is performed to the polymer film after the molecular imprint template 200 is pressed into the polymer film 212. However, in this embodiment, as shown in FIG. 3A, after the polymer film 212 is formed on the substrate 210, the polymer film is first cured and the molecular imprint template 200 is pressed into the cured polymer film. Analogously, the method described herein can avoid electrostatic damages and micro particle contamination suffered in the conventional rubbing method. Further, the depth, the pitch and the direction of the microgrooves are well controlled, so that the alignment direction of the LC molecules is accurately controlled and the viewing angle of the liquid crystal monitors is increased.

Embodiment 3

FIG. 4 is a display top view of the molecular imprint template for forming the alignment film with the wide viewing angle, according to another preferred embodiment of this invention. For the molecular imprint method described in this invention, the microgrooves formed in the alignment film are accurately complementary to the protruding portions of the embossment in the molecular imprint template. However, in the prior art rubbing process, it is difficult to control the direction of the microgrooves. Compared with the prior art rubbing process, in this invention, the direction or the profile of microgroove in the alignment film can be precisely tailor-made according to the requirements, by controlling the direction or profile of the embossment in the molecular imprint template. Referring to FIG. 4, taking a pixel range of the molecular imprint template as an example, the molecular imprint template 400 is obtained by depositing a silicon oxide film onto a surface of the substrate using tilt evaporation or by processing through micro-manipulation to generate micro-slots. In the molecular imprint template 400, the micro-slots are arranged in four phases and extend in four different directions 402, 404, 406, 408 (shown as arrows). Because the micro-slots of the molecular imprint template 400 are arranged in different directions, the alignment film that is imprinted by the molecular imprint template 400 has microgrooves in four different directions in one pixel. For the alignment, the LC molecules in one pixel are aligned along the four directions of the microgrooves, thus increasing the viewing angle of the liquid crystal monitors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for forming a non-rubbing alignment film, comprising following steps of:
providing a substrate;
forming a polymer film on the substrate;
pressing a surface of a molecular imprint template onto the polymer film, wherein the surface of the molecular imprint template has a plurality micro-slots; and
removing the molecular imprint template.

2. The method of claim 1, wherein the substrate is a glass substrate.

3. The method of claim 1, wherein the substrate is a plastic substrate.

4. The method of claim 1, wherein the substrate is a semiconductor substrate.

5. The method of claim 1, wherein the substrate is a thin film transistor array substrate.

6. The method of claim 1, wherein the substrate is color filter substrate.

7. The method of claim 1, wherein the material for forming the polymer film comprises polyimide compound.

8. The method of claim 1, wherein the material for forming the polymer film comprises polyamide compound.

9. The method of claim 1, further comprising a step of performing curing process after the polymer film is formed on the substrate.

10. The method of claim 9, wherein the curing process comprises a thermal process.

11. The method of claim 9, wherein the curing process comprises a UV irradiation process.

12. The method of claim 10, wherein the temperature used in the thermal process is below 200° C.

13. The method of claim 1, further comprising a step of performing curing process after pressing the surface of the molecular imprint template onto the polymer film.

14. The method of claim 13, wherein the curing process is a thermal process.

15. The method of claim 13, wherein the curing process is a UV irradiation process.

16. The method of claim 14, wherein the temperature used in the thermal process is below 200° C.

17. A method for forming a non-rubbing alignment film, comprising following steps of:
forming a polymer film on a substrate;
performing a curing process to cure the polymer film;
pressing a surface of molecular imprint template onto the polymer film, wherein the surface of the molecular imprint template has a plurality micro-slots; and
removing the molecular imprint template.

18. The method of claim 17, the substrate is a glass substrate.

19. The method of claim 17, the substrate is a plastic substrate.

20. The method of claim 17, the substrate is a semiconductor substrate.

21. The method of claim 17, wherein the substrate is a thin film transistor array substrate.

22. The method of claim 17, wherein the substrate is a color filter substrate.

23. The method of claim 17, wherein a material for forming the polymer comprises polyimide compound.

24. The method of claim 17, wherein a material for forming the polymer comprises polyamide compound.

25. The method of claim 17, wherein the curing process comprises a thermal process.

26. The method of claim 17, wherein the curing process comprises a UV irradiation process.

27. The method of claim 25, wherein the temperature used in the thermal process is below 200° C.

28. A method for forming a non-rubbing alignment film of a liquid crystal display, comprising following steps of:
forming a polymer film on a substrate; and
forming a plurality of grooves on the polymer film by a molecular imprint process.

29. The method of claim 28, the substrate is a glass substrate.

30. The method of claim 28, the substrate is a plastic substrate.

31. The method of claim 28, the substrate is a semiconductor substrate.

32. The method of claim 28, wherein the substrate is a thin film transistor array substrate.

33. The method of claim 28, wherein the substrate is a color filter substrate.

34. The method of claim 28, wherein the material for forming the polymer film comprises polyimide compound.

35. The method of claim 28, wherein the material for forming the polymer film comprises polyamide compound.

36. The method of claim 28, further comprising a step of performing curing process after the polymer film is formed on the substrate.

37. The method of claim 36, wherein the curing process comprises a thermal process.

38. The method of claim 36, wherein the curing process comprises a UV irradiation process.

39. The method of claim 37, wherein the temperature used in the thermal process is below 200° C.

40. The method of claim 28, wherein the molecular imprinting process comprises following steps of:
pressing a surface of molecular imprint template onto the polymer film, wherein the surface of the molecular imprint template has a plurality micro-slots; and
removing the molecular imprint template.

41. The method of claim 40, further comprising a step of performing curing process after pressing the surface of the molecular imprint template onto the polymer film.

42. The method of claim 41, wherein the curing process is a thermal process.

43. The method of claim 41, wherein the curing process is a UV irradiation process.

44. The method of claim 42, wherein the temperature used in the thermal process is below 200° C.
